(19) United States
(12) Patent Application Publication
(10) Pub. No.: US 2024/0095824 A1
(43) Pub. Date: Mar. 21, 2024

(54) METHOD AND SYSTEM FOR SIMULATION OF LIMIT ORDER BOOK MARKETS

(71) Applicant: JPMorgan Chase Bank, N.A., New York, NY (US)

(72) Inventors: Andrea COLETTA, Ferentino (IT); Svitlana VYETRENKO, Colts Neck, NJ (US); Tucker Richard BALCH, Suwanee, GA (US)

(73) Assignee: JPMorgan Chase Bank, N.A., New York, NY (US)

(21) Appl. No.: 18/210,852

(22) Filed: Jun. 16, 2023

Related U.S. Application Data
(60) Provisional application No. 63/408,656, filed on Sep. 21, 2022.

(51) Int. Cl. G06Q 40/04

(52) U.S. Cl. CPC G06Q 40/04

(57) ABSTRACT

A method for using an artificial intelligence (AI) model to simulate a limit order book market in order to facilitate study and evaluation of trading strategies is provided. The method includes: receiving information that relates to a state of the market at a particular time; and determining, based on the information, a potential market action that is expected to occur. The determination is made by applying an AI algorithm that implements a machine learning technique to determine the potential market action. The AI algorithm is trained by using historical data that relates to the market.

### CROSS-REFERENCE TO RELATED APPLICATIONS

This application claims priority benefit from U.S. Provisional Application No. 63/408,656, filed Sep. 21, 2022, which is hereby incorporated by reference in its entirety.

### BACKGROUND

### 1. Field of the Disclosure

This technology generally relates to methods and systems for simulating a market, and more particularly to methods and systems for using an artificial intelligence (AI) model to simulate a limit order book market in order to facilitate study and evaluation of trading strategies.

### 2. Background Information

Financial markets are among the most complex systems in existence. Naturally described as multi-agent systems, they comprise thousands of interacting heterogeneous participants. In recent times, both researchers and traders have heavily relied on artificial market models, to support the design of algorithms, as well as testing novel trading strategies. Artificial market models can help to isolate and study the impact of new algorithms to the price and volume of the stocks; they can explain the nature of some rare financial market phenomena, such as bubbles and crashes; and they can also be used to study and test trading strategies, before approaching the real market.

A significant volume of previous work has focused on multi-agent modeling, which is a natural bottom-up approach to emulate financial markets. In these models, a number of decision-makers (i.e., agents or traders) and institutions interact through prescribed rules to build the market. Several multi-agent simulators have been developed, by traders and researchers. However, modeling a realistic market through a multi-agent simulation is still a major challenge. In this regard, specifying how the agents should behave and interact in the simulation is not trivial. While some agents can be modeled following a common sense or historical analysis, in general, market participants adopt unknown proprietary trading strategies. Moreover, publicly available historical data does not include attribution to the various market participants, which makes the calibration of the agents challenging.

Accordingly, there is a need for a mechanism for using an artificial intelligence (AI) model to simulate a limit order book market in order to facilitate study and evaluation of trading strategies.

### SUMMARY

The present disclosure, through one or more of its various aspects, embodiments, and/or specific features or sub-components, provides, inter alia, various systems, servers, devices, methods, media, programs, and platforms for methods and systems for using an artificial intelligence (AI) model to simulate a limit order book market in order to facilitate study and evaluation of trading strategies.

According to an aspect of the present disclosure, a method for simulating a market is provided. The method is implemented by at least one processor. The method includes: receiving, by the at least one processor, first information that relates to a state of the market at a particular time; and determining, by the at least one processor based on the first information, at least one potential market action that is expected to occur. The determining includes applying a first AI algorithm that implements a machine learning technique to determine the at least one potential market action. The AI algorithm is trained by using historical data that relates to the market.

The first information may include at least one from among volume imbalance information that relates to a predetermined number of levels of a limit order book associated with the market, absolute volume information that relates to the predetermined number of levels of the limit order book, order-sign imbalance information that relates to at least one from among a first predetermined number of most recent market events and a first predetermined time window, market spread information, and price return information that relates to at least one from among a second predetermined number of the most recent market events and a second predetermined time window.

The at least one potential market action may include at least one from among an add limit order action, a market order action, a cancel order action, and a replace order action.

The applying of the AI algorithm may generate an output vector that includes price information that relates to a price of the at least one potential market action, quantity information that relates to a number of shares associated with the at least one potential market action, order type information that relates to a type of the at least one potential market action, side information that indicates whether the at least potential market action is a sell action or a buy action, and arrival time information that relates to an interarrival time of a next potential market action.

The price information may include depth information that relates to a difference between the price of the at least one potential market action and one from among a best-bid price and a best-ask price that corresponds to the at least one potential market action.

When the at least one potential market action includes at least one from among a cancel order action and a replace order action, the output vector may further include cancel depth information that relates to an order book level and queue position information that relates to a specific order at the order book level.

The AI algorithm may use a conditional generative adversarial network (CGAN) model that implements a conditional Wasserstein generative adversarial network with gradient penalty.

The method may further include inputting, into the CGAN model, a predetermined amount of random noise having a Gaussian distribution, and first information that corresponds to the respective states of the market at a predetermined number of consecutive times that includes a current time.

The historical data may include a set of data that corresponds to a predetermined time interval of at least three days.

According to another exemplary embodiment, a computing apparatus for simulating a market is provided. The computing apparatus includes a processor; a memory; and a communication interface coupled to each of the processor and the memory. The processor is configured to: receive, via the communication interface, first information that relates to a state of the market at a particular time; and determine, based on the first information, at least one potential market action that is expected to occur, by applying a first AI algorithm that implements a machine learning technique to determine the at least one potential market action. The AI algorithm is trained by using historical data that relates to the market.

The first information may include at least one from among volume imbalance information that relates to a predetermined number of levels of a limit order book associated with the market, absolute volume information that relates to the predetermined number of levels of the limit order book, order-sign imbalance information that relates to at least one from among a first predetermined number of most recent market events and a first predetermined time window, market spread information, and price return information that relates to at least one from among a second predetermined number of the most recent market events and a second predetermined time window.

The at least one potential market action may include at least one from among an add limit order action, a market order action, a cancel order action, and a replace order action.

The processor may be further configured to generate, as a result of the application of the AI algorithm, an output vector that includes price information that relates to a price of the at least one potential market action, quantity information that relates to a number of shares associated with the at least one potential market action, order type information that relates to a type of the at least one potential market action, side information that indicates whether the at least potential market action is a sell action or a buy action, and arrival time information that relates to an interarrival time of a next potential market action.

The price information may include depth information that relates to a difference between the price of the at least one potential market action and one from among a best-bid price and a best-ask price that corresponds to the at least one potential market action.

When the at least one potential market action includes at least one from among a cancel order action and a replace order action, the output vector may further include cancel depth information that relates to an order book level and queue position information that relates to a specific order at the order book level.

The AI algorithm may use a conditional generative adversarial network (CGAN) model that implements a conditional Wasserstein generative adversarial network with gradient penalty.

The processor may be further configured to input, into the CGAN model, a predetermined amount of random noise having a Gaussian distribution, and first information that corresponds to the respective states of the market at a predetermined number of consecutive times that includes a current time.

The historical data may include a set of data that corresponds to a predetermined time interval of at least three days.

According to yet another exemplary embodiment, a non-transitory computer readable storage medium storing instructions for simulating a market is provided. The storage medium includes executable code which, when executed by a processor, causes the processor to: receive first information that relates to a state of the market at a particular time; and determine, based on the first information, at least one potential market action that is expected to occur, by applying a first AI algorithm that implements a machine learning technique to determine the at least one potential market action. The AI algorithm is trained by using historical data that relates to the market.

The first information may include at least one from among volume imbalance information that relates to a predetermined number of levels of a limit order book associated with the market, absolute volume information that relates to the predetermined number of levels of the limit order book, order-sign imbalance information that relates to at least one from among a first predetermined number of most recent market events and a first predetermined time window, market spread information, and price return information that relates to at least one from among a second predetermined number of the most recent market events and a second predetermined time window.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using an AI model to simulate a limit order book market in order to facilitate study and evaluation of trading strategies.

FIG. 4 is a flowchart of an exemplary process for implementing a method for using an AI model to simulate a limit order book market in order to facilitate study and evaluation of trading strategies.

FIG. 5 is a diagram that illustrates a snapshot of a limit order book market structure, according to an exemplary embodiment.

FIG. 6 is a flow diagram that illustrates a mixture of parametric distributions in an AI model to be used for simulating a limit order book market in order to facilitate study and evaluation of trading strategies, according to an exemplary embodiment.

FIG. 7 is a diagram that illustrates a conditional generative adversarial network (CGAN) architecture to be used in an implementation of a method for using an AI model to simulate a limit order book market in order to facilitate study and evaluation of trading strategies, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

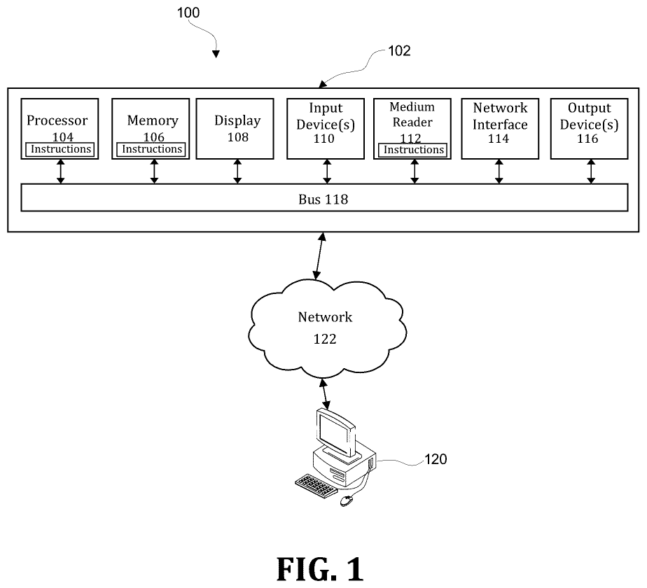

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using an AI model to simulate a limit order book market in order to facilitate study and evaluation of trading strategies.

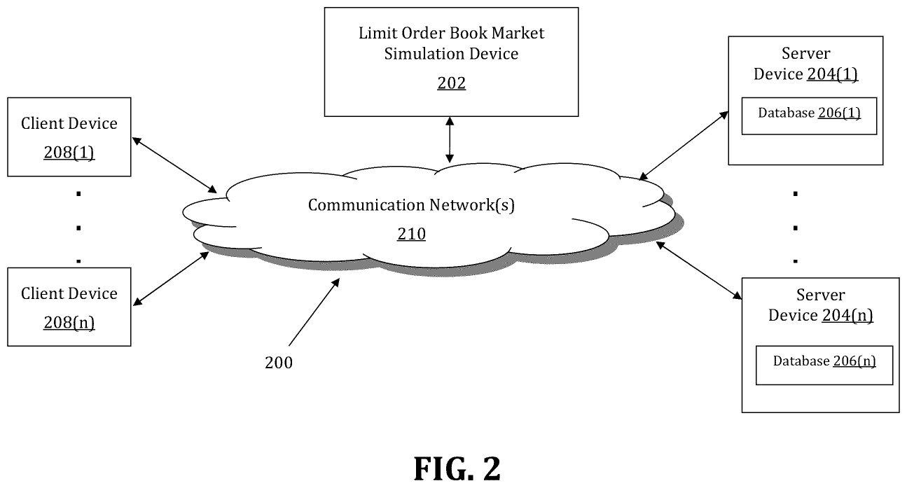

Referring to FIG. 2, a schematic of an exemplary network environment 200 for implementing a method for using an AI model to simulate a limit order book market in order to facilitate study and evaluation of trading strategies is illustrated. In an exemplary embodiment, the method is executable on any networked computer platform, such as, for example, a personal computer (PC).

The method for using an AI model to simulate a limit order book market in order to facilitate study and evaluation of trading strategies may be implemented by a Limit Order Book Market Simulation (LOBMS) device 202. The LOBMS device 202 may be the same or similar to the computer system 102 as described with respect to FIG. 1. The LOBMS device 202 may store one or more applications that can include executable instructions that, when executed by the LOBMS device 202, cause the LOBMS device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the LOBMS device 202 itself, may be located in virtual server(s) running in a cloud-based computing environment rather than being tied to one or more specific physical network computing devices. Also, the application(s) may be running in one or more virtual machines (VMs) executing on the LOBMS device 202. Additionally, in one or more embodiments of this technology, virtual machine(s) running on the LOBMS device 202 may be managed or supervised by a hypervisor.

In the network environment 200 of FIG. 2, the LOBMS device 202 is coupled to a plurality of server devices 204(1)-204(n) that hosts a plurality of databases 206(1)-206(n), and also to a plurality of client devices 208(1)-208(n) via communication network(s) 210. A communication interface of the LOBMS device 202, such as the network interface 114 of the computer system 102 of FIG. 1, operatively couples and communicates between the LOBMS device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the LOBMS device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and LOBMS devices that efficiently implement a method for using an AI model to simulate a limit order book market in order to facilitate study and evaluation of trading strategies.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The LOBMS device 202 may be a standalone device or integrated with one or more other devices or apparatuses, such as one or more of the server devices 204(1)-204(n), for example. In one particular example, the LOBMS device 202 may include or be hosted by one of the server devices 204(1)-204(n), and other arrangements are also possible. Moreover, one or more of the devices of the LOBMS device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the LOBMS device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical market data and data that relates to market-specific parameters and metrics.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the LOBMS device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the LOBMS device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the LOBMS device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the LOBMS device 202, the server devices 204(1)-204(n), or the client devices 208(1)-208(n), for example, may be configured to operate as virtual instances on the same physical machine. In other words, one or more of the LOBMS device 202, the server devices 204(1)-204(n), or the client devices 208(1)-208(n) may operate on the same physical device rather than as separate devices communicating through communication network(s) 210. Additionally, there may be more or fewer LOBMS devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

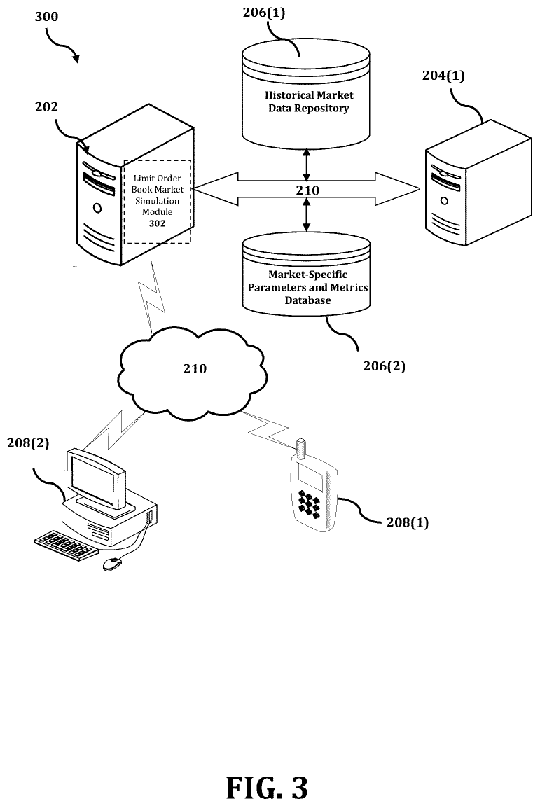

The LOBMS device 202 is described and illustrated in FIG. 3 as including a limit order book market simulation module 302, although it may include other rules, policies, modules, databases, or applications, for example. As will be described below, the limit order book market simulation module 302 is configured to implement a method for using an AI model to simulate a limit order book market in order to facilitate study and evaluation of trading strategies.

An exemplary process 300 for implementing a mechanism for using an AI model to simulate a limit order book market in order to facilitate study and evaluation of trading strategies by utilizing the network environment of FIG. 2 is illustrated as being executed in FIG. 3. Specifically, a first client device 208(1) and a second client device 208(2) are illustrated as being in communication with LOBMS device 202. In this regard, the first client device 208(1) and the second client device 208(2) may be “clients” of the LOBMS device 202 and are described herein as such. Nevertheless, it is to be known and understood that the first client device 208(1) and/or the second client device 208(2) need not necessarily be “clients” of the LOBMS device 202, or any entity described in association therewith herein. Any additional or alternative relationship may exist between either or both of the first client device 208(1) and the second client device 208(2) and the LOBMS device 202, or no relationship may exist.

Further, LOBMS device 202 is illustrated as being able to access a historical market data repository 206(1) and a market-specific parameters and metrics database 206(2). The limit order book market simulation module 302 may be configured to access these databases for implementing a method for using an AI model to simulate a limit order book market in order to facilitate study and evaluation of trading strategies.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the LOBMS device 202 via broadband or cellular communication. Of course, these embodiments are merely exemplary and are not limiting or exhaustive.

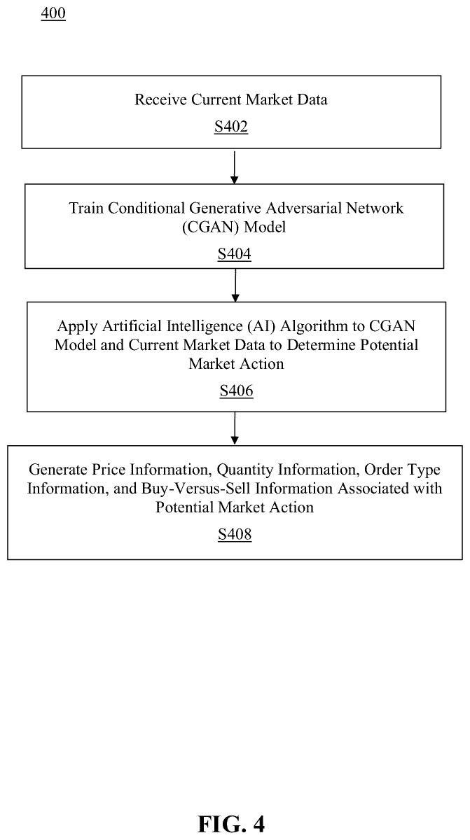

Upon being started, the limit order book market simulation module 302 executes a process for using an AI model to simulate a limit order book market in order to facilitate study and evaluation of trading strategies. An exemplary process for using an AI model to simulate a limit order book market in order to facilitate study and evaluation of trading strategies is generally indicated at flowchart 400 in FIG. 4.

In process 400 of FIG. 4, at step S402, the limit order book market simulation module 302 receives first information that relates to a state of the market at a particular time. In an exemplary embodiment, the first information may include any one or more of volume information that relates to a predetermined number of levels of a limit order book associated with the market, absolute volume information that relates to the predetermined number of levels of the limit order book, order-sign imbalance information that relates to a first predetermined number of most recent market events and/or a first predetermined time window, market spread information, and price return information that relates to a second predetermined number of the most recent market events and/or a second predetermined time window.

At step S404, the limit order book market simulation module 302 trains a model that is to be used in conjunction with an AI algorithm that is designed to simulate the market. In an exemplary embodiment, the model is a conditional generative adversarial network (CGAN) model that implements a conditional Wasserstein generative adversarial network with gradient penalty. In an exemplary embodiment, the CGAN model is trained by using historical market data, such as, for example, data that corresponds to a predetermined time interval, such as, for example, three days, five days, two weeks, or a month.

At step S406, the limit order book market simulation module 302 applies the AI algorithm to the trained CGAN model and to the first information received in step S402 in order to determine at least one potential market action that is expected to occur. In an exemplary embodiment, the potential market action may include any one or more of an add limit order action, a market order action, a cancel order action, and a replace order action.

In an exemplary embodiment, inputs to the CGAN model may include a predetermined amount of random noise having a Gaussian distribution and first information that corresponds to respective states of the market at a predetermined number of consecutive times that includes a current time. For example, the input to the CGAN model may include 10 sets of first information that include a first set that corresponds to the current time and nine additional sets that correspond to the nine most recent times that immediately precede the current time. Alternatively, the input may include three such sets of first information, five such sets of first information, 15 such sets of first information, 40 such sets of first information, 100 such sets of first information, or any other suitable number of sets of first information.

At step S408, the limit order book market simulation module 302 generates an output vector as a result of the application of the AI algorithm. In an exemplary embodiment, the output vector includes price information that relates to a price of the potential market action; quantity information that relates to a number of shares associated with the potential market action; order type information that relates to a type of the potential market action; side information that indicates whether the potential action is a sell action or a buy action; and arrival time information that relates to an interarrival time of a next potential market action.

In an exemplary embodiment, the price information may include depth information that relates to a difference between the price of the potential market action and either a best-bid price or a best-ask price that corresponds to a financial instrument associated with the potential market action. In an exemplary embodiment, when the potential market action is either a cancel order action or a replace order action, the output vector may further include cancel depth information that relates to an order book level and queue position information that relates to a specific order at the order book level.

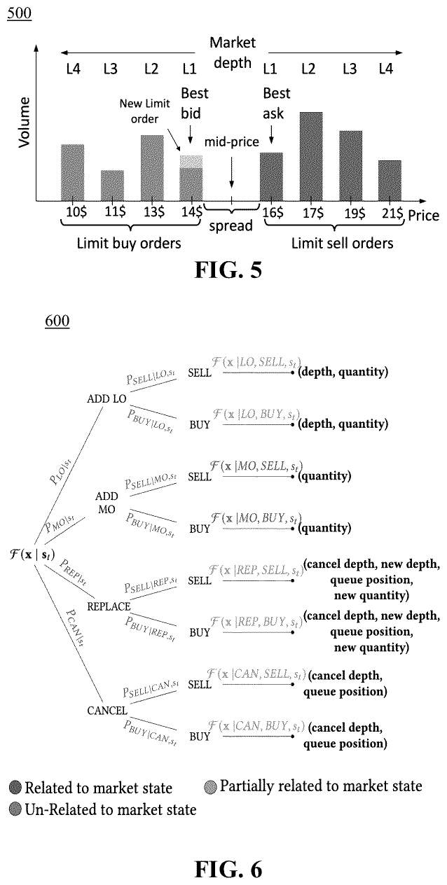

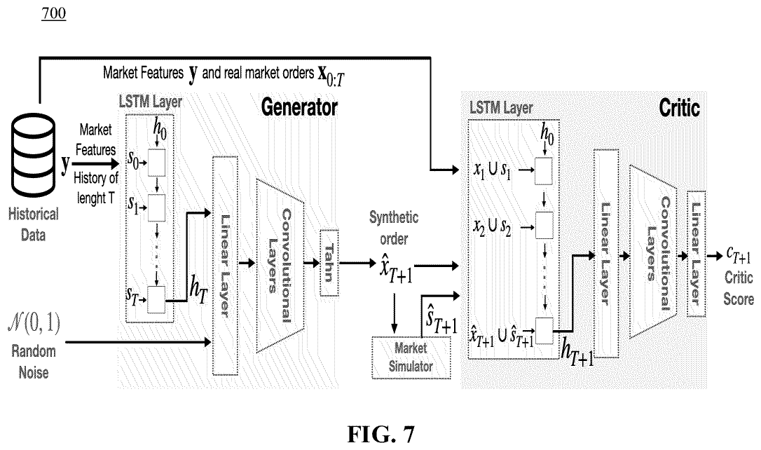

FIG. 5 is a diagram 500 that illustrates a snapshot of a limit order book market structure, according to an exemplary embodiment. FIG. 6 is a flow diagram 600 that illustrates a mixture of parametric distributions in an AI model to be used for simulating a limit order book market in order to facilitate study and evaluation of trading strategies, according to an exemplary embodiment. FIG. 7 is a diagram 700 that illustrates a conditional generative adversarial network (CGAN) architecture to be used in an implementation of a method for using an AI model to simulate a limit order book market in order to facilitate study and evaluation of trading strategies, according to an exemplary embodiment.

Multi-agent market simulators generally require careful calibration to emulate real markets, which includes the number and the type of agents. Poorly calibrated simulators can lead to misleading conclusions, potentially causing severe loss when employed by investment banks, hedge funds, and traders to study and evaluate trading strategies. Traditional approaches fall short with respect to learning and calibrating trader population, as historical labeled data with details on each individual trader strategy is not publicly available.

In an exemplary embodiment, a world model simulator that accurately emulates a limit order book market is provided. This simulator requires no agent calibration, but instead learns the simulated market behavior directly from historical data. This approach proposes to learn a unique “world” agent from historical data. It is intended to emulate the overall trader population, without the need of making assumptions about individual market agent strategies. The world agent simulator models are implemented as a Conditional Generative Adversarial Network (CGAN), as well as a mixture of parametric distributions.

Earlier versions of the world agent were simplistic, in that it was only capable of placing limit orders which usually account for just 50% of all trading actions. Nevertheless, it has been shown that this model could reproduce stylized facts as well as some form of market impact of trading. Hence, the present disclosure provides an attempt to a realistic and responsive world model.

In an exemplary embodiment, the design of the CGAN-based world model is improved by extending it to support all main market actions (i.e., market order, add limit order, cancel order, and replace order), and the model is described alongside another world model constructed explicitly as a mixture of parametric distributions. Moreover, the CGAN robustness and stability is improved by unrolling the model during the training.

Limit order book: Financial markets offer a place for buyers and sellers to meet and trade on different assets. Modern electronic markets, such as NASDAQ, provide ad-hoc message protocols to facilitate trades, and also provide real-time information about the market order flow and state. In particular, the ITCH protocol provides access to anonymized market data with highest granularity, including all the orders in the market. The main four fundamental orders are: Market orders, Add limit orders, Cancel orders, and Replace orders. They respectively indicate the intention of trading a given amount of shares at any price; the intention of trading shares at a fixed limit price; a cancellation of a previous limit order; and a modification to a previous limit order (e.g., a change in the price or quantity).

Most equity markets employ a continuous-time double auction mechanism to handle the stream of orders, and to execute a transaction whenever a buyer and seller agree on the price. To store the supply and demand for each asset, the market exchange uses an electronic record called limit order book (LOB). The LOB keeps a record of all outstanding limit orders into different levels, organized by price, and it continuously updates them according to incoming orders. FIG. 5 shows a snapshot 500 of a LOB with the available supply and demand. The first bars (L1) represent the first level, the second bars (L2) the second level, and so on. Each bar keeps the outstanding orders into a queue structure. An add limit order to buy will update the existing demand, increasing the queue size; while a cancel order will decrease the queue size, and consequently reduce supply or demand.

Artificial Market Properties—Realism: Evaluating trading strategies against poorly calibrated market models can lead to poor and misleading conclusions, potentially causing severe loss when these strategies are employed on real markets. To assess the realism of artificial models, researchers commonly evaluate their ability to reproduce statistical properties of real markets called stylized facts. For example, as asset daily returns usually have fat tail distribution and long-range dependence, one would expect the same properties, i.e., the same stylized facts, from artificial markets. In an exemplary embodiment, consideration is given to auto-correlations, heavy tails distribution, and long range dependence to evaluate asset return properties. In addition, consideration is also given to order volumes, time to first fill, depth and market spread distributions, in order to evaluate the volumes and order flow.

Artificial Market Properties—Responsiveness: Another desirable property of artificial market models is the responsiveness to exogenous trading orders: the model should emulate the market reaction to new orders, providing a tool to investigate strategies' impact on the market. For example, the arrival of several buy (sell) market orders commonly causes the rise (fall) of the price. This phenomenon is called price impact, and it is desirable that a responsive model exhibit this behavior.

Generative Models and CGANs: In recent times, generative models have been successfully employed in a wide range of scenarios, ranging from images to time-series. A generative model is any model able to learn a probability distribution p_{model} resembling the real data distribution p_{data}, from a set of real samples. Among generative models, two major approaches are typically employed: a) models that explicitly estimate the probability density function; b) and models that implicitly learn to generate samples without the need of an explicit density function.

Generative Adversarial Networks (GANs): GANs are powerful generative models that consider two adversarial neural networks, which implicitly learn to generate data samples. In particular, a generator G and a discriminator D are trained simultaneously to compete in the following min-max game:

$${min}_{G} {max}_{D} {𝔼}_{x ∼ {p}_{data} ( ( x ) )} [ log ( D ( ( x ) ) ) ] + {𝔼}_{z ∼ {p}_{z} ( z )} [ log ( 1 - D ( G ( z ) ) ) ]$$

The generator G(z) produces new realistic samples from a prior noise distribution p_{z} (z), while the discriminator distinguishes between real and synthetic samples. Both networks aim at maximizing their own utility function: as the training advances, the discriminator D learns to reject synthetic samples generated by G, which in turn learns to generate more realistic data to fool the discriminator. This two-player game trains the model to generate realistic samples resembling the real data.

In an exemplary embodiment, a world model aims at generating realistic market actions in accordance with the current market, to provide realism and responsiveness to trading orders. Therefore, consideration is given to a conditional GAN. A CGAN generates realistic samples conditioned by some extra information y, representing the market state in this case. The CGAN will include information about ongoing events, including outstanding trading orders. Both generator and discriminator incorporate this extra information resulting into the following game:

$${min}_{G} {max}_{D} {𝔼}_{x ∼ {p}_{data} ( ( x ) )} [ log ( D ( x \vert y ) ) ] + {𝔼}_{z ∼ {p}_{z} ( z )} [ log ( 1 - D ( G ( z \vert y ) ) ) ]$$

In an exemplary embodiment, the world model provides a novel approach to market simulation: it considers a unique world agent trained on historical data to emulate the entire population of traders, without the need of individual market agent strategies. The world agent observes the market state and generates the next trading action emulating the behavior of the real traders.

Formally, the world agent can be described as a conditional probability distribution F (x|y) that generates the next market action x given some information y about the market. The action x represents a trading order to the exchange, which advances the simulation into a new market state. Thus, by iteratively generating new orders, the simulation advances in time, exploiting the world agent to generate the market.

Actions: Consideration is given to four possible actions representing the main trading orders, which are defined as follows: 1) Add Limit Order is a 3-tuple composed by <depth, side, quantity>; 2) Market Order is a 2-tuple composed by <side, quantity>; 3) Cancel Order is a 3-tuple composed by <cancel depth, side, queue position>; and 4) Replace Order is a 5-tuple composed by <cancel depth, side, queue position, new depth, new quantity>.

Several parameters are introduced, including pₐⁱ(t), vₐⁱ(t), p_{b}ⁱ(t), v_{b}ⁱ(I) as the price and volume size at i-th level of the LOB, at time t, for ask and bid respectively. The depth d(t) of a limit order describes the order price p(t) with respect to the best-bid and best-ask as follows:

$$p ( t ) = \{ \begin{matrix}{p}_{b}^{1} ( t ) - d ( t ) , & If side = BID \\ {p}_{a}^{1} ( t ) + D ( t ) , & Else\end{matrix}$$

Consideration is preferably given to depths rather than prices, in order to improve model stability. In this aspect, depths are almost stationary, conversely to prices that change over time.

The side and quantity describe the amount of shares and the side of an order (i.e., bid or ask), respectively. Cancel depth and queue position are used to cancel and replace orders, as they accurately describe cancellation and replacement dynamics of real markets. In particular, the cancel depth identifies the order book level, while the queue position identifies the specific order at that level.

Market state: Modeling the market state plays the fundamental role of conditioning the generative model, to produce accurate and responsive actions. An introduction is provided for a set of features that best describe the current market sₜ at time t, and the ongoing events.

The volume imbalance Iⁱ (t) is defined as the demand and supply inequality within the first ilevels:

$${I}^{i} ( t ) = \frac{{\sum }_{j = 1}^{i} {υ}_{b}^{j} ( t )}{{\sum }_{j = 1}^{i} {υ}_{b}^{j} ( t ) + {υ}_{a}^{j} ( t )}$$

The volume inequality is a strong predictor of the future price change, and provides a view of the current market state.

Along the imbalance, a definition is provided for the absolute volume Vⁱ (t) within the first ilevels:

$${V}^{i} ( t ) = {\sum }_{j = 1}^{i} {υ}_{b}^{j} ( t ) + {υ}_{a}^{j} ( t )$$

This feature helps the model balancing between cancel and limit orders, and generating accurate quantities and depths, to keep consistent volumes over the day.

The order-sign imbalance ON (t) for a history window of N events is defined as follows:

$${O}_{N} ( t ) = \frac{1}{N} {\sum }_{j = t - N}^{t} ϵ ( j )$$

where ϵ(j) is the sign of a market order at event-time j, if any. By definition, ϵ(j)=1 for a sell market order, and ϵ(j)=−1 for a buy market order. This feature provides knowledge about the price trend in the recent history, and about price impact phenomena. The market spread δ(t) is defined as follows:

δ(t)=pₐ¹(t)−p_{b}¹(t)

The market spread helps the model balancing between liquidity provider and liquidity taker behavior, and to shape order depths.

The price return r N (t) for a history window of N events is defined as follows:

$${r}_{N} ( t ) = \frac{{m}_{( t )}}{{m}_{( t - N )}} - 1$$

The returns describe the current market trends.

Explicit model—Mixture of parametric distributions: In an exemplary embodiment, a simple and understandable world agent model based on classic parametric distributions is introduced. It is observed that the considered trading actions are composed of ordinal features with an unbounded range (e.g., quantity) but also relatively well-balanced categorical features (i.e., side and order type). Therefore, consideration is given to a world agent expressed as a product of successive conditional distributions. The generation process is initially conditioned with categorical features, which allows for a breakdown of the order distributions into smaller conditional pieces, which are modeled with simple distributions. FIG. 6 illustrates an approach in which the order type and side break down the complexity of the generation process, and condition the ordinal features (e.g., depth and quantity). As shown in FIG. 6, the following abbreviations are used: LO, MO, REP, and CAN, to identify add limit orders, market orders, replace orders, and cancel orders, respectively.

The decomposition makes the world agent easier and more understandable, because each distribution can be fitted directly on the data, and independently from other distributions. Classic and well-studied distributions are employed. In an exemplary embodiment, closed-form maximum likelihood or moment matching estimators are used to fit the distributions' parameters. For example, P_{LO|St} is fitted as a fixed probability estimated using empirical proportions of actions in the historical data. At the second level of conditioning, P_{SELL|}LO,_{St} is fitted using only historical data in which the trading actions are limit order placements. To easily decompose the problem, and make it tractable and understandable, the following assumptions are made: for limit order placement and replacement, it is assumed that depth and quantity are independent; and for order replacement, it is assumed that new depth and new quantity are independent from the former ones.

The distributions used for the categorical features are now introduced. For the order type, a multinomial distribution fitted on historical data is used, while the side consists of a binomial distribution conditioned on the order type and the volume imbalance I⁵(t), using a logistic model per each type. The logistic models show high probability of generating a BID limit order when I⁵(t)≈0, which indicates that most of the volume is on the ASK side, and vice versa.

Once the order type and side have been identified, the following distributions are used to capture each specific order feature:

The depth of a limit or replace order is described by a mixture of a beta-binomial distribution and an empirical multinomial distribution. The first distribution models negative depths while the latter accounts for positive depths. The probability of having a negative depth is modeled with a logistic regression, dependent on the market spread δ(t) and volume imbalance I⁵(t).

The order quantity is represented as a mixture of two negative-binomial distributions. It is observed that most of the investors trade quantities that are multiples of 100 shares, therefore one distribution describes quantities that are multiples of 100, and the other distribution is used for quantities that are not multiples of 100.

The cancel depth is represented by using a negative-binomial distribution, considering replace and cancel orders separately.

The cancel queue position is modeled by using a beta-binomial distribution, considering replace and cancel orders separately.

The inter-arrival time of orders is modeled by fitting a gamma distribution on historical data. The inter-arrival time is the time between two consecutive orders, and it determines when the world agent is triggered to generate another trading action. Both world models use this gamma distribution to model the inter-arrival times. In an exemplary embodiment, a time to fill for limit orders, which is strongly related to the order inter-arrival times, may also be used.

CGAN model: Referring to FIG. 7, diagram 700 illustrates an architecture of a CGAN-based world agent implemented through a conditional Wasserstein GAN with gradient penalty (WGAN-GP). In an exemplary embodiment, consideration is given to a WGAN-GP, as it provides a more stable training and allows to deal with discrete data. In particular, the WGAN-GP minimizes the Wasserstein-1 distance between real and synthetic data distributions, which is continuous and differentiable almost everywhere. In a WGAN-GP, the discriminator does not classify samples, but it rather outputs a real value evaluating their realism, thus it may be referred to as a “critic”. Note that in contrast with explicit model learning as described above, the CGAN architecture does not take any parametric assumptions, and hence can be more easily extended to training on data that represents stocks with different dynamics.

Model input: In an exemplary embodiment, the CGAN generator G(z|y) takes as input a vector of Gaussian random noise z˜N (0, 1) and a vector y containing market information. The market state at time t is represented as an ordered vector sₜ defined as follows:

st={I¹(t),I⁵(t),O₁₂₈(t),O₂₅₆(t),V¹(t),V⁵(t),δ(t),r₁(t),r₅₀(1)}

To capture the market evolution over time, y is defined as the concatenation of the last T historical market states: yₜ={s_{t-T}, . . . , sₜ}. In an exemplary embodiment, while most of the features take values in [−1, 1], a normalization is made for V¹(t), V⁵(t) and δ(t) so that these values fall between −1 and 1, using a mix-max scaler.

Model output: In an exemplary embodiment, the generator outputs a synthetic trading action, which may have different attributes upon its type: a market order has a side and a quantity, while an add limit order also requires a specific depth. To have a universal representation for all the orders, consideration is given to an output vector X\hat{ } including all the possible attributes:

x\hat{ }=(depth, cancel depth, qtyx, qty₁₀₀x, qty type, order type, side)

The order type assumes values in {−1, 0, 1} and it discriminates between market orders, add limit orders and cancel orders. In the CGAN architecture, the replace orders are represented and learned by a sequence of a cancel and an add limit order. The order quantity is represented by 3-attributes, namely qtyₓ, qty₁₀₀ₓ and qty type, and it is defined as follows:

$$quantity = \{ \begin{matrix}{qty}_{x} , & If qty type = 1 \\ 100 \cdot {qty}_{100 x} , & Else\end{matrix}$$

As described above, most of the investors trade multiples of 100 shares, thus qty type is used to discriminate their orders, and qty₁₀₀x is used to learn the hundreds digits of the quantity. The side assumes values in {−1, 1} and it distinguishes SELL and BUY orders. Finally, the depth and cancel depth assume discrete values in Z, and they represent the price of the order to add or modify, respectively. To reduce the action space, the queue position is predicted through a beta-binomial distribution considering its stable and regular distribution.

In an exemplary embodiment, all of the non-categorical attributes are normalized between −1 and 1. Moreover, depending on the order type, only some attributes are meaningful and used: for an add limit order, consideration is given to both depth, side and quantity attributes, but for a cancel order consideration is given to just the cancel depth and the side.

Model training and architecture: FIG. 7 shows a CGAN architecture 700 according to an exemplary embodiment. In particular, the CGAN improves stability and responsiveness by unrolling the model during the training. In another embodiment, the model is trained using only ground truth market states: at each training iteration the CGAN receives a real market state sₜ to generate the next order xₜ₊₁. At test time, when the model is employed, and unrolled in a closed-loop simulation, the CGAN may encounter unseen states induced by a previous sequence of sub-optimal actions. Unseen states can lead to poor and misleading simulation, such as, for example, exponential market growth.

In an exemplary embodiment, in order to mitigate unseen and unrealistic market states, the generated orders are fed into a simulator that advances the market state, and the critic is used for evaluating both generated orders and states during the training. Most important, the model is unrolled during training: in particular, a generation of k steps ahead is performed, feeding the model with the previous generated market states. This approach enforces the model to deal with synthetic market states, improving stability and realism: actions that led to unrealistic states will be penalized, while also minimizing unseen states.

Accordingly, with this technology, a process for using an AI model to simulate a limit order book market in order to facilitate study and evaluation of trading strategies is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for simulating a market, the method being implemented by at least one processor, the method comprising:
receiving, by the at least one processor, first information that relates to a state of the market at a particular time; and
determining, by the at least one processor based on the first information, at least one potential market action that is expected to occur,
wherein the determining comprises applying a first artificial intelligence (AI) algorithm that implements a machine learning technique to determine the at least one potential market action, the AI algorithm being trained by using historical data that relates to the market.

2. The method of claim 1, wherein the first information includes at least one from among volume imbalance information that relates to a predetermined number of levels of a limit order book associated with the market, absolute volume information that relates to the predetermined number of levels of the limit order book, order-sign imbalance information that relates to at least one from among a first predetermined number of most recent market events and a first predetermined time window, market spread information, and price return information that relates to at least one from among a second predetermined number of the most recent market events and a second predetermined time window.

3. The method of claim 1, wherein the at least one potential market action includes at least one from among an add limit order action, a market order action, a cancel order action, and a replace order action.

4. The method of claim 3, wherein the applying of the AI algorithm generates an output vector that includes price information that relates to a price of the at least one potential market action, quantity information that relates to a number of shares associated with the at least one potential market action, order type information that relates to a type of the at least one potential market action, side information that indicates whether the at least one potential market action is a sell action or a buy action, and arrival time information that relates to an interarrival time of a next potential market action.

5. The method of claim 4, wherein the price information includes depth information that relates to a difference between the price of the at least one potential market action and one from among a best-bid price and a best-ask price that corresponds to the at least one potential market action.

6. The method of claim 4, wherein when the at least one potential market action includes at least one from among a cancel order action and a replace order action, the output vector further includes cancel depth information that relates to an order book level and queue position information that relates to a specific order at the order book level.

7. The method of claim 1, wherein the AI algorithm uses a conditional generative adversarial network (CGAN) model that implements a conditional Wasserstein generative adversarial network with gradient penalty.

8. The method of claim 7, further comprising inputting, into the CGAN model, a predetermined amount of random noise having a Gaussian distribution, and first information that corresponds to the respective states of the market at a predetermined number of consecutive times that includes a current time.

9. The method of claim 1, wherein the historical data comprises a set of data that corresponds to a predetermined time interval of at least three days.

10. A computing apparatus for simulating a market, the computing apparatus comprising:
a processor;
a memory; and
a communication interface coupled to each of the processor and the memory,
wherein the processor is configured to:
receive, via the communication interface, first information that relates to a state of the market at a particular time; and
determine, based on the first information, at least one potential market action that is expected to occur, by applying a first artificial intelligence (AI) algorithm that implements a machine learning technique to determine the at least one potential market action,
wherein the AI algorithm is trained by using historical data that relates to the market.

11. The computing apparatus of claim 10, wherein the first information includes at least one from among volume imbalance information that relates to a predetermined number of levels of a limit order book associated with the market, absolute volume information that relates to the predetermined number of levels of the limit order book, order-sign imbalance information that relates to at least one from among a first predetermined number of most recent market events and a first predetermined time window, market spread information, and price return information that relates to at least one from among a second predetermined number of the most recent market events and a second predetermined time window.

12. The computing apparatus of claim 10, wherein the at least one potential market action includes at least one from among an add limit order action, a market order action, a cancel order action, and a replace order action.

13. The computing apparatus of claim 12, wherein the processor is further configured to generate, as a result of the application of the AI algorithm, an output vector that includes price information that relates to a price of the at least one potential market action, quantity information that relates to a number of shares associated with the at least one potential market action, order type information that relates to a type of the at least one potential market action, side information that indicates whether the at least potential market action is a sell action or a buy action, and arrival time information that relates to an interarrival time of a next potential market action.

14. The computing apparatus of claim 13, wherein the price information includes depth information that relates to a difference between the price of the at least one potential market action and one from among a best-bid price and a best-ask price that corresponds to the at least one potential market action.

15. The computing apparatus of claim 13, wherein when the at least one potential market action includes at least one from among a cancel order action and a replace order action, the output vector further includes cancel depth information that relates to an order book level and queue position information that relates to a specific order at the order book level.

16. The computing apparatus of claim 10, wherein the AI algorithm uses a conditional generative adversarial network (CGAN) model that implements a conditional Wasserstein generative adversarial network with gradient penalty.

17. The computing apparatus of claim 16, wherein the processor is further configured to input, into the CGAN model, a predetermined amount of random noise having a Gaussian distribution, and first information that corresponds to the respective states of the market at a predetermined number of consecutive times that includes a current time.

18. The computing apparatus of claim 10, wherein the historical data comprises a set of data that corresponds to a predetermined time interval of at least three days.

19. A non-transitory computer readable storage medium storing instructions for simulating a market, the storage medium comprising executable code which, when executed by a processor, causes the processor to:
receive first information that relates to a state of the market at a particular time; and
determine, based on the first information, at least one potential market action that is expected to occur, by applying a first artificial intelligence (AI) algorithm that implements a machine learning technique to determine the at least one potential market action,
wherein the AI algorithm is trained by using historical data that relates to the market.

20. The storage medium of claim 19, wherein the first information includes at least one from among volume imbalance information that relates to a predetermined number of levels of a limit order book associated with the market, absolute volume information that relates to the predetermined number of levels of the limit order book, order-sign imbalance information that relates to at least one from among a first predetermined number of most recent market events and a first predetermined time window, market spread information, and price return information that relates to at least one from among a second predetermined number of the most recent market events and a second predetermined time window.
